(19) United States
(12) Patent Application Publication
(10) Pub. No.: US 2003/0087780 A1
(43) Pub. Date: May 8, 2003

(54) Rinsing and drying aid for a vehicle

(76) Inventor: Edward Holbus, Racine, WI (US)

Correspondence Address: QUARLES & BRADY LLP, 411 E. WISCONSIN AVENUE, SUITE 2040, MILWAUKEE, WI, 53202-4497, US

(21) Appl. No.: 10/284,616

(22) Filed: Oct. 31, 2002

Related U.S. Application Data
(60) Provisional application No. 60/336,503, filed on Nov. 2, 2001.

(51) Int. Cl. C11D 1/00

(52) U.S. Cl. 510/189; 510/417

(57) ABSTRACT

A coating composition that can be applied to a vehicle as a rinsing and drying aid after the vehicle has been washed is disclosed. The coating composition may be prepared and sold without water as a dilutable concentrate, or may be sold in a pre-mixed diluted aqueous solution to which additional water may or may not be added at the vehicle washing installation before the diluted coating composition is applied to a vehicle. In one embodiment, the composition includes water, a non-chlorinated cationic emulsifier, and a petroleum-based hydrocarbon distillate oil, wherein the weight ratio of the petroleum-based hydrocarbon distillate oil to the non-chlorinated cationic emulsifier is in the range of 0.5:1 to 10:1.

### CROSS REFERENCES TO RELATED APPLICATIONS

This application claims priority from United States Provisional Patent Application No. 60/336,503, filed Nov. 2, 2001.

### BACKGROUND OF THE INVENTION

1. Field of the Invention

The present invention relates to coating compositions that can be applied to a vehicle as a rinsing and drying aid after the vehicle has been washed.

2. Description of the Related Art

Automatic car washes have achieved widespread use in the United States. A typical automatic car wash cleans the surface of a vehicle by successive washing, rinsing and drying operations. In the washing operation, water and detergents are typically sprayed onto the vehicle surface. In the rinsing operation, water is sprayed onto the vehicle surface to remove any detergent. Drying is typically performed by a jet of air.

In order to facilitate the drying and removal of water from the vehicle, a rinse aid is usually applied to the vehicle surface during or after rinsing to assist drying of the vehicle surface. The rinse aid spreads over the vehicle surface and causes water that is present to bead up on the surface so that the surface may be more quickly blown dry with the jet of air. The rinse aid acts as a water repellent film on the vehicle surface in which the hydrophobic nature of the film induces water present on the vehicle surface to bead up, and to be more easily blown dry by a jet of air. The rinse aid may also improve the appearance of the vehicle by providing a gloss or luster to the vehicle surface.

These advantageous properties of rinse aids have led to their widespread use in automatic car washes. However, certain known rinse aid formulations may contain components which for a variety of reasons have become relatively undesirable. For instance, known rinse aid formulations may contain chlorine containing compounds such as chlorinated cationic surfactants. The environmental friendliness of chlorinated chemicals has come into question recently. For instance, when a rinse aid formulator uses chlorinated surfactants in a rinse aid, the rinse aid has been required to carry a toxic to fish label by certain United States environmental regulatory agencies. Also, chlorinated surfactants may accelerate the formation of rust on vehicles. Known rinse aid formulations may also contain glycol ethers which in certain forms can be toxic.

Thus, it would be desirable to provide a rinsing and drying aid that does not include chlorine containing compounds and glycol ethers. However, simply removing the chlorine containing compounds and glycol ethers from a conventional rinse aid formulation is far from straightforward because of the balance of properties that must be realized by a new rinse aid that is substantially free from chlorine containing compounds and glycol ethers. That is, the new rinse aid must not only reduce the environmental risks, but must also promote the rapid formation of a relatively hydrophobic surface, thereby promoting the desired beading to promote the removal of water.

Thus, there is a continuing need for environmentally friendly coating compositions that can be applied to a vehicle as a rinsing and drying aid after the vehicle has been washed.

### SUMMARY OF THE INVENTION

The foregoing needs in the art are achieved by a coating composition according to the present invention that can be applied to a vehicle as a rinsing and drying aid after the vehicle has been washed. The coating composition may be prepared and sold with little water as a dilutable concentrate, or may be sold in a pre-mixed diluted aqueous solution to which additional water may or may not be added at the vehicle washing installation before the diluted coating composition is applied to a vehicle. In one embodiment, the composition includes water, a non-chlorinated cationic emulsifier, and a petroleum-based hydrocarbon distillate oil, wherein the weight ratio of the petroleum-based hydrocarbon distillate oil to the non-chlorinated cationic emulsifier is in the range of 0.5:1 to 10:1.

In one aspect, the invention is a coating composition concentrate that can be diluted with water to form an aqueous solution for post-wash application to a vehicle body surface as a rinsing and drying aid. In another aspect, the invention is a pre-mixed diluted aqueous composition that can be further diluted (if desired) to form an aqueous solution for post-wash application to a vehicle body surface as a rinsing and drying aid. In yet another aspect, the invention is a method for rinsing and drying a vehicle surface comprising applying an aqueous composition according to the invention to a substantially clean vehicle surface and drying the vehicle surface by a jet of air and/or wiping. A coating composition concentrate and a pre-mixed diluted aqueous composition according to the invention are essentially free of chlorinated compounds and glycol ethers.

These and other features, aspects, and advantages of the present invention will become better understood upon consideration of the following detailed description and accompanying example, which have been presented for the purposes of illustration and not limitation.

### DETAILED DESCRIPTION OF THE INVENTION

The present invention provides a coating composition concentrate that can be diluted with water to form an aqueous solution for post-wash application to a vehicle body surface as a rinsing and drying aid. The coating composition concentrate includes water, a non-chlorinated cationic emulsifier and a petroleum-based hydrocarbon distillate oil. In one specific embodiment of the invention, the coating composition concentrate consists essentially of water, the non-chlorinated cationic emulsifier and the petroleum-based hydrocarbon distillate oil. Upon the addition of further water to the coating composition concentrate, an aqueous solution for post-wash application to a vehicle body surface as a rinsing and drying is formed. No components other than water are needed to form the aqueous rinsing and drying aid. A coating composition concentrate and a pre-mixed diluted aqueous composition according to the invention are essentially free of chlorinated compounds and glycol ethers.

The concentrated composition includes water, a non-chlorinated cationic emulsifier and a petroleum-based hydrocarbon distillate oil, wherein the weight ratio of the petroleum-based hydrocarbon distillate oil to the non-chlorinated cationic emulsifier is in the range of 0.5:1 to 10:1. Preferably, the weight ratio of the petroleum-based hydrocarbon distillate oil to the non-chlorinated cationic emulsifier is in the range of 0.5:1 to 5:1. Even more preferably, the weight ratio of the petroleum-based hydrocarbon distillate oil to the non-chlorinated cationic emulsifier is in the range of 0.5:1 to 3:1. Most preferably, the weight ratio of the petroleum-based hydrocarbon distillate oil to the non-chlorinated cationic emulsifier is in the range of 0.75:1 to 1.5:1.

The non-chlorinated cationic emulsifier may be a salt of a fatty amine. The alkyl groups of such fatty amines have from 8 to 22 carbon atoms, and may include a mixture of C₈ to C₂₂ alkyl groups, which may be substituted or unsubstituted. Suitable amine salts include the acetate, phosphate, nitrate, citrate, lactate and sulfate salts. One example non-chlorinated cationic emulsifier is a tallow alkyl amine acetate available under the trademark “ARMAC” T from Akzo Nobel Surface Chemistry, Chicago, Ill., USA. “ARMAC” T is a mixture of 95-100% by weight of tallow alkyl amine acetates, 0.001-5% by weight of ditallow alkyl amine acetates, and 0.001-5% by weight of tallow alkyl amines.

Suitable petroleum-based hydrocarbon distillate oils include mineral oils and mineral seal oils. One example hydrocarbon distillate oil is a mineral seal oil available under the trademark “KERMAC” 600 from Kerr-McGee Refining Corporation, Houston, Tex., USA. “KERMAC” 600 is a mixture of C₁₃ to C₁₉ hydrocarbons.

In one example embodiment of the coating composition, the coating composition is a mixture including 1 part by weight of a non-chlorinated fatty alkyl amine salt cationic emulsifier and 0.75-1.5 parts by weight of a petroleum-based hydrocarbon distillate oil. In the example embodiment of the concentrated coating composition, the preferred cationic emulsifier is a tallow alkyl amine acetate, and the preferred petroleum-based hydrocarbon distillate oil is mineral seal oil.

The example embodiment of the concentrated coating composition is prepared by heating the emulsifier above its melting point if necessary and blending the liquid emulsifier and the petroleum-based hydrocarbon distillate oil together. If desired, the concentrated coating composition may then be formed into an aqueous solution for post-wash application to a vehicle body surface as a rinsing and drying aid by blending the concentrated coating composition into heated water. The amount of water used in the aqueous composition depends on the desired results of the end user. For example, certain users may highly dilute the aqueous composition and therefore, would expect to receive a more concentrated aqueous solution. Likewise, other users may only slightly dilute the aqueous composition and therefore, would expect to receive a less concentrated aqueous solution. Also, certain users may choose to receive a completely, undiluted concentrated coating composition which can be subsequently diluted. In one version, the composition includes 50% to 99% by weight based on the total weight of the composition of water. In another version, the composition includes 70% to 99% by weight based on the total weight of the composition of water. In yet another version, the composition includes 80% to 99% by weight based on the total weight of the composition of water.

Another example embodiment of the aqueous composition is formed by preparing a 40 pound sample of the emulsifier and the oil using any of the above ratios and adding sufficient water to the 40 pound sample to prepare 55 gallons of solution. Thus, this aqueous composition includes 80-96% water by weight of the total weight of the aqueous composition, 0.5-10% by weight of the total weight of the aqueous composition of the non-chlorinated fatty alkyl amine salt cationic emulsifier, and 2-10% by weight of the total weight of the aqueous composition of the petroleum-based hydrocarbon distillate oil.

Typically, the concentrated coating composition is supplied to a vehicle washing installation as part of the diluted aqueous solution. However, certain users may wish to receive the concentrated coating composition and dilute it with water to form the aqueous rinsing and drying aid. At the vehicle washing installation, the aqueous solution is generally contained in a 55-gallon drum, and a feed pump is used to draw the aqueous solution out of the 55-gallon drum into a spray arch where the aqueous solution may be further diluted with hot or cold water and then forced through spray nozzles onto a vehicle. The aqueous solution is typically applied during or after rinsing. The aqueous solution forms a water repellent film on the vehicle surface that induces water present on the vehicle surface to bead up, and to be more easily blown dry by a jet of air and/or dried by light wiping. The aqueous solution also improves the appearance of the vehicle by providing a gloss or luster to the vehicle surface.

### EXAMPLE

This Example serves to illustrate the invention. It is not intended to limit the invention in any way. An aqueous solution for post-wash application to a vehicle body surface as a rinsing and drying aid was prepared using the following components:

| | | Weight Percent |
|---|---|---|
| | Weight | (Based on Total |
| Component | (lbs.) | Weight) |
| Tallow alkyl amine acetate | 22 | 4.93% |
| (“ARMAC” T) | | |
| Mineral seal oil (“KERMAC” | 27 | 6.05% |
| 600) | | |
| Water | Water to 55 gallons | 89.02% |
| TOTALS | | 100.0% |

The tallow alkyl amine acetate (“ARMAC” T) and the mineral seal oil (“KERMAC” 600) are heated together to at least 132° F. to form a liquid. The liquid is then stirred into heated water (about 180° F.) to form an aqueous solution for post-wash application to a vehicle body surface as a rinsing and drying aid.

Therefore, there has been provided a coating composition concentrate that can be diluted with water to form an aqueous solution for post-wash application to a vehicle body surface as a rinsing and drying aid. The coating composition concentrate and a pre-mixed diluted aqueous composition according to the invention are essentially free of chlorinated compounds and glycol ethers.

Although the present invention has been described in considerable detail with reference to certain embodiments, one skilled in the art will appreciate that the present invention can be practiced by other than the described embodiments, which have been presented for purposes of illustration and not of limitation. Therefore, the scope of the appended claims should not be limited to the description of the embodiments contained herein.

What is claimed is:

1. A composition that can be diluted with water to form an aqueous rinsing and drying aid for post-wash application to a vehicle surface, the composition comprising:
water;
a non-chlorinated cationic emulsifier; and
a petroleum-based hydrocarbon distillate oil,
wherein the weight ratio of the petroleum-based hydrocarbon distillate oil to the non-chlorinated cationic emulsifier is in the range of 0.5:1 to 10:1.

2. The composition of claim 1 wherein:
the composition is essentially free of chlorinated compounds.

3. The composition of claim 1 wherein:
the petroleum-based hydrocarbon distillate oil is a mineral seal oil.

4. The composition of claim 1 wherein:
the non-chlorinated cationic emulsifier is selected from the group consisting of salts of fatty amines having a substituted or unsubstituted C₈ to C₂₂ alkyl group or a mixture of substituted or unsubstituted C₈ to C₂₂ alkyl groups.

5. The composition of claim 1 wherein:
the non-chlorinated cationic emulsifier is an acetate salt of a fatty amine having a mixture of C₁₆ to C₁₈ alkyl groups.

6. The composition of claim 1 wherein:
the weight ratio of the petroleum-based hydrocarbon distillate oil to the non-chlorinated cationic emulsifier is in the range of 0.5:1 to 5:1.

7. The composition of claim 1 wherein:
the weight ratio of the petroleum-based hydrocarbon distillate oil to the non-chlorinated cationic emulsifier is in the range of 0.5:1 to 3:1.

8. The composition of claim 1 wherein:
the weight ratio of the petroleum-based hydrocarbon distillate oil to the non-chlorinated cationic emulsifier is in the range of 0.75:1 to 1.5:1.

9. The composition of claim 1 wherein the composition comprises:
50% to 99% by weight based on the total weight of the composition of water.

10. The composition of claim 1 wherein the composition comprises:
70% to 99% by weight based on the total weight of the composition of water.

11. The composition of claim 1 wherein the composition comprises:
80% to 99% by weight based on the total weight of the composition of water.

12. The composition of claim 1 wherein:
the composition is essentially free of glycol ethers.

13. The composition of claim 1 wherein the composition consists essentially of:
water;
a non-chlorinated cationic emulsifier; and
a petroleum-based hydrocarbon distillate oil,
wherein the weight ratio of the petroleum-based hydrocarbon distillate oil to the non-chlorinated cationic emulsifier is in the range of 0.5:1 to 10:1.

14. The composition of claim 13 wherein:
the petroleum-based hydrocarbon distillate oil is a mineral seal oil.

15. The composition of claim 14 wherein:
the non-chlorinated cationic emulsifier is selected from the group consisting of salts of fatty amines having a substituted or unsubstituted C₈ to C₂₂ alkyl group or a mixture of substituted or unsubstituted C₈ to C₂₂ alkyl groups.

16. The composition of claim 15 wherein:
the weight ratio of the petroleum-based hydrocarbon distillate oil to the non-chlorinated cationic emulsifier is in the range of 0.5:1 to 3:1.

17. The composition of claim 16 wherein the composition comprises:
80% to 99% by weight based on the total weight of the composition of water.

18. A method for cleaning a vehicle surface, the method comprising:
applying a cleaning composition to a vehicle surface;
thereafter rinsing the cleaning composition from the vehicle surface;
thereafter applying to the vehicle surface the aqueous composition of claim 1; and
thereafter drying the vehicle surface by a jet of air and/or wiping.

19. A composition that can be diluted with water to form an aqueous rinsing and drying aid for post-wash application to a vehicle surface, the composition comprising:
80-99% by weight based on the total weight of the composition of water;
a non-chlorinated cationic emulsifier; and
a petroleum-based hydrocarbon distillate oil,
wherein the weight ratio of the petroleum-based hydrocarbon distillate oil to the non-chlorinated cationic emulsifier is in the range of 0.5:1 to 3:1,
wherein the composition is essentially free of chlorinated compounds, and
wherein the composition is essentially free of glycol ethers.

20. A method for cleaning a vehicle surface, the method comprising:
applying a cleaning composition to a vehicle surface;
thereafter rinsing the cleaning composition from the vehicle surface;
thereafter applying to the vehicle surface the aqueous composition of claim 19; and
thereafter drying the vehicle surface by a jet of air and/or wiping.
